(19) United States
(12) Patent Application Publication
(10) Pub. No.: US 2015/0223509 A1
(43) Pub. Date: Aug. 13, 2015

(54) COMPOSITIONS AND METHODS FOR PROVIDING COCONUT WATER POWDER WITH REDUCED HYGROSCOPY

(71) Applicant: BRUCE L. HOWE, San Diego, CA (US)

(72) Inventor: BRUCE L. HOWE, San Diego, CA (US)

(21) Appl. No.: 14/588,966

(22) Filed: Jan. 4, 2015

Related U.S. Application Data
(60) Provisional application No. 61/923,329, filed on Jan. 3, 2014.

(51) Int. Cl. A23L 2/39; A23L 2/12; A23L 2/10

(52) U.S. Cl. CPC A23L 2/39; A23L 2/102; A23L 2/12; A23L 2/107; A23L 2/10

(57) ABSTRACT

Coconut water powder is highly hygroscopic and has a strong tendency to absorb ambient moisture. As coconut water powder absorbs water, it begins caking and ultimately forms a hard, solid mass that is difficult to use in the manufacture and formulation of coconut water-based beverages, drink mixes and foods. The present invention is based on the discovery that the addition of comestible oils, such as coconut oil, prior to dehydration of coconut water results in a coconut water powder with greatly reduced hyrgoscopy. Compositions comprising coconut water powder with reduced hygroscopy are the subject of the invention, as are methods of making and using such compositions.

### CROSS-REFERENCE TO RELATED APPLICATIONS

This application claims priority to provisional application Ser. No. 61/923,329, filed Jan. 3, 2014, the entire contents of which are incorporated herein by reference as if set forth verbatim.

### FIELD OF THE INVENTION

The invention is in the field of beverages and nutritional supplements. More particularly, the invention relates to formulations for reducing the hygroscopy of coconut water powder.

### BACKGROUND

The consumption of coconut water provides significant hydration and nutritional benefits. Coconut water may be prepared from powdered concentrates derived from dehydrated coconut water. However, when dried using conventional drying methods (e.g. freeze drying, drum drying, spray drying, radiant heat, infrared and microwave) the resulting coconut water powder is highly hygroscopic and has a strong tendency to absorb ambient moisture. As the coconut water powder absorbs water, it begins caking and forms a hard, solid mass. Coconut water powder in the form of a solid mass is impractical for manufacturing or end-user applications since the solid mass cannot easily be divided, dissolved or measured. The hygrscopy of coconut water powder also makes it impractical to ship and/or store the powder since the powder cannot be exposed to ambient moisture.

What is needed in the art therefore is a formulation and method for reducing the absorption of ambient moisture by coconut water powder.

### SUMMARY OF THE INVENTION

The invention overcomes the problem of the solidification of coconut water powder by providing formulations and methods that inhibit the absorption of ambient moisture by the coconut water powder. Applicant discovered that combining coconut water with coconut oil prior to dehydrating the coconut water results in a coconut water powder with greatly reduced hygroscopy.

It is therefore an objective of the invention to provide a coconut water powder having reduced hygrsocopy, wherein the coconut water powder is derived from a mixture of coconut water and coconut oil, wherein the coconut water and the coconut oil are present in a ratio of between about 50:1 to about 25:1, respectively.

A further objective of the invention is to provide a method for producing coconut water powder having reduced hygroscopy, said method comprising providing coconut water, providing coconut oil, combining the coconut water and the coconut oil to provide a coconut water-oil mixture, and dehydrating the coconut water-oil mixture under conditions sufficient to produce a powder.

A further objective of the invention is to provide a method for producing coconut water powder having reduced hygroscopy, the method comprising providing coconut water, providing coconut oil, combining the coconut water and the coconut oil to provide a coconut water-oil mixture, and dehydrating the coconut water-oil mixture under conditions sufficient to produce a powder, wherein the coconut water and the coconut oil are present in a ratio of between about 50:1 to about 25:1, respectively.

A further objective of the invention is to provide a coconut water powder that avoids solidification due to the absorption of ambient moisture, the coconut water powder comprising dehydrated coconut water and coconut oil, wherein the dehydrated coconut water and the coconut oil are present in a ratio of between about 50:1 to about 25:1, respectively.

A further objective of the invention is to provide a method for manufacturing coconut water, the method comprising providing coconut water powder, and dissolving the coconut water powder in water, wherein the coconut water powder comprises dehydrated coconut water and coconut oil in a ratio of between about 50:1 to about 25:1, respectively.

A further objective of the invention is to provide a method for formulating a liquid for producing coconut water powder having reduced hygroscopy, the method comprising providing coconut water, providing coconut oil, and combining the coconut water and the coconut oil to produce a coconut water-oil mixture, wherein the coconut water and the coconut oil are present in a ratio of between about 50:1 to about 25:1, respectively.

A further objective of the invention is to provide a liquid formulation for producing coconut water powder having reduced hygroscopy, the liquid formulation comprising coconut water, and coconut oil, wherein the coconut water and the coconut oil are present in a ratio of between about 50:1 to about 25:1, respectively,.

A further objective of the invention is to provide a coconut water drink mix comprising dehydrated coconut water and coconut oil, wherein the dehydrated coconut water and the coconut oil are present in a ratio of between about 50:1 to about 25:1, respectively,

### DEFINITIONS

As used herein, the term “hygroscopy” refers to the ability of a substance (e.g. coconut water powder) to attract and hold water molecules from the surrounding environment (e.g. ambient moisture).

As used herein, the term “coconut water” refers to the clear liquid inside young coconuts (fruits of the coconut palm). Coconut water may be fresh (i.e. not rehydrated or reconstituted), reconstituted from a concentrate, rehydrated from coconut water powder, or a combination thereof.

As used herein, the term “coconut water powder” refers to the solids that remain after coconut water is dehydrated.

As used herein, the term “dehydrated,” “freeze dried,” “dry” or “dried,” refer to a moisture level in a substance of between about 10% to about 3%.

As used herein the term “reduced hygroscopy,” “inhibiting hygroscopy,” “inhibiting the absorption of ambient water,” and the like are used to refer to any measurable decrease in the hygroscopy of a substance that results from a set of conditions, relative to the hydrogscopy of the substance in the absence of such conditions.

As used herein, the term “about” refers to a value that is 20%, 15%, 10%, 9%, 8%, 7%, 6%, 5%, 4%, 3%, 2%, 1%, 0.5%, 0.1%, 0.05%, or 0.01% of the stated value, as well as values intervening such stated values.

As used herein, the term “purified” means that a substance is at least 70% free of contamination with other substances.

### DETAILED DESCRIPTION

The invention generally relates to the manufacture and use of coconut water powder. More particularly, the invention relates to the manufacture and use of a coconut water powder having reduced hygroscopy and a reduced tendency to solidify due to the absorption of ambient moisture.

Coconut water can be produced from coconut water powder. Such powders are produced by dehydrating coconut water under suitable drying methods, such as freeze drying or radiant heat. The resulting powder however is very hygroscopic and has a strong tendency to absorb ambient moisture. As the powder absorbs ambient moisture, it begins clumping and forms a solid mass that is difficult to use in applications such as the manufacturing of coconut water and end-user coconut water powder consumer products such as nutritional supplements and drink mixes. Applicant however discovered that the hygroscopy of coconut water powder can be greatly reduced by adding coconut oil to coconut water prior to dehydrating the coconut water. Applicant discovered that coconut water powder produced by such methods has a greatly reduced tendency to clump and solidify despite being exposed to ambient moisture. Without being limited to any particular theory, the addition of the coconut oil acts as a coating agent, or hygroscopic barrier, that inhibits the coconut water powder from absorbing ambient moisture.

Some aspects of the invention provide a method for preparing a coconut water powder that avoids solidification due to the absorption of ambient moisture. One non-limiting embodiment of such methods may be practiced by providing a quantity of coconut water to be dehydrated, and adding to the coconut water an amount of coconut oil sufficient to reduce hygroscopy of coconut powder prior to dehydrating the coconut water. Prior to adding the coconut oil to the coconut water, the coconut oil may be heated so that it achieves a viscosity that facilitates its mixing with the coconut water. Once sufficiently mixed together, the coconut oil and coconut water mixture may be dried to form a powder according to suitable methods known in the art such as freeze drying, drum drying, spray drying, radiant heat, infrared, microwave or a combination thereof, for example. It is also contemplated that such powders may be combined with other powders such as flavors and powdered nutrient compositions. It is also contemplated that carriers and anti-caking agents may be added to the coconut water prior to dehydration in addition to coconut oil. Such carriers and anti-caking agents include, but are not limited to, maltodextrins, and gum such as guar gum, acacia gum, or xanthan gums, silica and combinations thereof.

Some aspects of the invention relate to providing a coconut water powder having reduced hygroscopy. Such powders may be produced by providing coconut water, combining the coconut water with a quantity of coconut oil to produce a coconut water-oil mixture, and dehydrating the coconut water-oil mixture under conditions sufficient to produce a powder. The quantity of coconut oil that is combined with the coconut water may be any amount that is sufficient to reduce the hygroscopy of the coconut water when the coconut water is dehydrated to form a powder. Non-limiting ratios for use with the invention include coconut water to coconut oil ratios of between about 50:1 to about 25:1, respectively, In aspects of the invention, ratios of coconut water to oil may be 50:1 to 45:1, 45:1 to 40:1, 40:1 to 35:1, 35:1 to 30:1, 30:1 to 25:1, 25:1 to 20:1, 20:1 to 15:1, 15:1 to 10:1, 10:1 or 5:1, as well as ratios intervening the stated ratios. Purified or non-purified coconut oil may be used as disclosed herein.

Some aspects of the invention relate to the moisture level that is present in the coconut water powder after drying. Coconut water powder as disclosed herein may have a moisture level of between about 10% to 3%. In some embodiments, the coconut water powder of the invention has a moisture level of 10%, 9%, 8%, 7%, 6%, 5%, 4%, 3%, 2% or 1%.

Some aspects of the invention relate to the starting material that is combined with coconut oil prior to dehydration. Accordingly, coconut oil may be combined with coconut water, coconut water concentrate, or a combination thereof, prior to dehydration.

In preferred embodiments, coconut oil is used as coconut oil prevents the sticking and oxidation of coconut water solids. In addition, coconut oil enhances the coconut flavor of the coconut water that results from rehydration of the inventive coconut water powder. It is contemplated however that coconut water (and/or coconut water concentrate) may be combined or replaced with other comestible oils. Such oils include, but are not limited to, vegetable oil, peanut oil, canola oil, sunflower oil, sunflower lecithin, soy lecithin, or a combination thereof. These ingredients may be used alone, or in combination with coconut oil. Animal, fish and microbally derived oils may also be used with, or in place of, coconut oil.

In some aspects, coconut water powder having reduced hygroscopy as disclosed herein is rehydrated to form a liquid. For example, coconut water powder having reduced hygroscopy is contacted with an amount of water sufficient to form a liquid. Such coconut water may be again dehydrated to form a powder, consumed as a beverage, such as coconut water, or combined with other comestible liquids, foods or formulations such as drink mixes.

In some aspects of the invention, the coconut water powder of the invention is packaged within a container. Suitable containers include, but are not limited to, bottles, bags, boxes, stick packs, and satchets. Such containers may be impermeable to water and made from materials including, but not limited to, glass, metal (e.g. aluminum, steel, tin or stainless steel), plastic, and polyurethane.

### EXAMPLE

25 ounces of coconut oil was heated to 100 degrees F. for 1 minute, then added to 5 gallons of coconut water and 1% silicon dioxide and 18% tapioca maltodextrin or Acacia gum, Guar gum or Xanthan gum. Ingredients were mixed for 10 minutes creating a homogenous slurry. This slurry was placed on trays in a vacuum and dried at −40 C for 24 hours until 3% moisture was achieved.

I claim:

1. A method for producing coconut water powder having reduced hygroscopy, said method comprising:
providing a quantity of coconut water;
providing a quantity of comestible oil sufficient to reduce the absorption of ambient moisture by the coconut water when the coconut water is reduced to a powder;
combining the quantity of coconut water with the quantity of comestible oil to produce a mixture;
drying the mixture for a time sufficient to reduce the mixture to a powder.

2. The method of claim 1, wherein the comestible oil is coconut oil.

3. The method of claim 1, wherein the ratio of coconut water to comestible oil is about 50:1 to about 25:1, respectively.

4. The method of claim 3, wherein the ratio is about 25:1.

5. The method of claim 1, wherein the mixture is dried by freeze drying, drum drying, spray drying, radiant heat, infrared, microwave or a combination thereof.

6. The method of claim 1, further comprising enclosing the powder in a container.

7. The method of claim 6, wherein the container is impermeable to water.

8. The method of claim 1, further comprising rehydrating the powder to produce coconut water.

9. A coconut water powder having reduced hygroscopy, the coconut water powder comprising coconut water solids derived from dehydrated coconut water and a comestible oil, wherein the coconut water solids and the comestible oil are in a ratio of about 50:1 to about 25:1, respectively.

10. The coconut water powder of claim 9, wherein the comestible oil is coconut oil.

11. The coconut water powder of claim 9, wherein the ratio is about 25:1.

12. The coconut water powder of claim 9, wherein the powder is in a container.

13. The coconut water powder of claim 12, wherein the container is impermeable to water.

14. The coconut water powder of claim 9, wherein the coconut water powder is rehydrated to form a liquid.

15. The coconut water powder of claim 13, wherein the liquid is coconut water.

16. A formulation for preparing a coconut water powder having reduced hygroscopy, the formulation comprising coconut water and a comestible oil in a ratio of about 50:1 to about 25:1.

17. The formulation of claim 16, wherein the comestible oil is coconut oil.

18. The formulation of claim 16, wherein the ratio is about 25:1.

19. The formulation of claim 16, wherein the formulation is dehydrated to form a powder.

20. The formulation of claim 19, wherein the powder is rehydrated to form a liquid.
